(19) United States
(12) Patent Application Publication
(10) Pub. No.: US 2021/0002898 A1
(43) Pub. Date: Jan. 7, 2021

(54) A SEALING DEVICE WITH REDUCED BLOCKING

(71) Applicant: SIKA TECHNOLOGY AG, Baar (CH)

(72) Inventors: Oliver KNEBEL, Luzern (CH); Robert ROSKAMP, Altdorf (CH); Simon SCHOENBRODT, Sarnen (CH); Armin FLÜCK, Kerns (CH)

(73) Assignee: SIKA TECHNOLOGY AG, Baar (CH)

(21) Appl. No.: 16/976,529

(22) PCT Filed: Mar. 14, 2019
(86) PCT No.: PCT/EP2019/056510

§ 371 Date: Aug. 28, 2020

(30) Foreign Application Priority Data
Mar. 16, 2018 (EP) 18162400.8

(51) Int. Cl. E04D 5/10; B32B 27/32; B32B 25/08; B32B 25/18; B29C 48/00; B29C 48/08; E04D 5/14

(52) U.S. Cl. CPC E04D 5/10; B29L 2031/108; B32B 25/08; B32B 25/18; B29C 48/0021; B29C 48/08; E04D 5/149; B32B 2307/7265; B32B 2419/06; B32B 2307/546; B32B 2307/732; B32B 2250/24; B32B 2250/05; B32B 2250/03; B29K 2995/0069; B32B 27/32

(57) ABSTRACT

A sealing device including a waterproofing membrane and a protective film including a backing layer, which is directly attached to at least part of the bottom surface of the waterproofing membrane. The invention is also directed to a method for producing a sealing device, to use of a protective film comprising a backing layer for reducing blocking of a polymeric membrane, and to a method for covering a roof substrate using the sealing devices of the present invention.

### TECHNICAL FIELD

The invention relates to polymeric sealing devices, which can be used for waterproofing of underground and above ground constructions, in particular for waterproofing of roofing structures.

### BACKGROUND OF THE INVENTION

Polymeric sheets, which are often referred to as membranes or panels, are commonly used to protect underground and above ground constructions, such as basements, tunnels, and flat and low-sloped roofs, against penetration water. State-of-the-Art waterproofing membranes include single-ply roofing membranes composed of one single waterproofing layer and multi-ply roofing membranes composed of two or more waterproofing layers having same or different compositions.

Commonly used materials for waterproofing membranes include plastics, in particular thermoplastics such as plasticized polyvinylchloride (p-PVC), thermoplastic elastomers (TPE), in particular thermoplastic olefins (TPO), and elastomers such as ethylene-propylene diene monomer (EPDM). The waterproofing membranes are typically delivered to a construction site in rolls, transferred to the place of installation, unrolled, and adhered to the substrate to be waterproofed. The substrate on which the waterproofing membrane is adhered may be comprised of variety of materials depending on the installation site. The substrate may be, for example, a concrete, metal, or wood deck, or it may include an insulation board or recover board and/or an existing membrane.

Depending on the application, the waterproofing membrane should be able to conform to various requirements. In roofing applications, the waterproofing membrane should have high enough mechanical strength in order to resist the shearing forces applied on it, for example caused by wind loads. In addition, the membrane should have high flexibility to enable easy installation on surface of roofing substrates, especially in corner and edge areas. Typically it is also advantageous that the material of the membrane is heat-weldable, i.e. the membranes can be adhered to each other by thermal bonding without using an adhesive or other adhering means.

Waterproofing membranes based on crosslinked EPDM are very flexible and resistant to weathering but they are not heat-weldable due to the chemically crosslinked structure of the polymer base. Consequently, seams between EPDM membranes have to be sealed using welding tapes produced from different materials than the membrane such as uncrosslinked EPDM or bonded with special adhesives developed for the crosslinked EPDM materials. Membranes composed of thermoplastic olefins (TPO) are heat-weldable and less expensive than EPDM-membranes but they are also more rigid which decreases their suitability for roofing applications. Membranes based on plasticized PVC are more flexible than TPO-based membranes but also they contain environmentally harmful plasticizers and heavy metal additives such as flame retardants that may restrict their use in some applications.

Due to the heat-weldability and lower production costs compared to crosslinked EPDM-membranes, TPO-membranes have gained a significant market share especially in European markets. In order to increase the flexibility of TPO-membranes, various approaches have been suggested. One approach is based on using multilayer membrane systems comprising a flexible EPDM-based core layer with top and bottom layers based on more rigid TPO-materials. Another approach has been to develop new TPO-compositions comprising increased amount of the elastomer component. However, increasing the elastomer content typically results in compositions with increased tackiness. Membranes produced using such compositions also exhibit increased blocking, which complicates various post-processing steps of the membranes such as cutting, welding, stacking, and unwinding from a roll. Blocking refers here to the increased adhesion of two adjacent polymeric layers. It occurs due to the presence of van der Waals forces between amorphous regions of the polymers. These forces increase with reduced distance between the two layers and, therefore, blocking increases when the layers are pressed together.

Various organic and inorganic antiblocking agents have been used to decrease the blocking of polyolefin layers. The tackiness of TPO-materials can also be reduced by crosslinking at least part of the elastomer component. Such modified TPO's can be obtained by melt-blending a statically or dynamically crosslinked elastomer component with a plastic component. TPEs containing a dynamically vulcanized (crosslinked) elastomer component are also known as thermoplastic vulcanizates (TPV, TPE-v). Despite the introduction of flexible TPO-compositions having decreased tackiness, blocking is still a problem especially if the membranes are stored in form of rolls for longer period of time in hot climate regions.

There is thus a need for a new polymeric sealing device, which exhibits reduced blocking when stored in form of rolls, in particular at elevated temperatures.

### SUMMARY OF THE INVENTION

The object of the present invention is to provide a sealing device comprising a waterproofing membrane having reduced blocking.

Another objective of the present invention is to provide a sealing device, which can be joined to other sealing devices having similar composition and to other polymeric articles such as waterproofing membranes by heat-welding.

It was surprisingly found out that the blocking of thermoplastic waterproofing membranes can be effectively reduced with a protective film comprising a backing layer attached directly to the bottom surface of a membrane.

The subject of the present invention is a sealing device as defined in claim 1.

One of the advantages of the sealing of the present invention is that the blocking of the waterproofing membrane can be effectively reduced without having any negative effects on the mechanical properties of the waterproofing membrane.

Another advantage of the sealing device of the present invention is that the edges of adjacent membranes can be joined together by heat-welding without removal of the protective film.

Other aspects of the present invention are presented in other independent claims. Preferred aspects of the invention are presented in the dependent claims.

### BRIEF DESCRIPTION OF THE DRAWINGS

FIG. 1 shows a cross-section of a sealing device (1) comprising a waterproofing membrane (2) and a protective film (3) comprising a backing layer (4), which is directly attached to the bottom surface of the waterproofing membrane (2).

FIG. 2 shows a cross-section of a sealing device (1) according to one embodiment of the present invention, wherein the protective film (3) comprises a backing layer (4), which is directly attached to the bottom surface of the waterproofing membrane (2), a second backing layer (6), and a barrier layer (5), which is located between the backing layers.

FIG. 3 shows a cross-section of a sealing device (1) according to another embodiment of the present invention, wherein the protective film (3) comprises a backing layer (4), which is directly attached to the bottom surface of the waterproofing membrane (2), a second backing layer (6) and a first barrier layer (5), which is located between the first and second backing layers (4, 6) as well as a third backing layer (8) and a second barrier layer (7), which is located between the second and third backing layers (6, 8).

### DETAILED DESCRIPTION OF THE INVENTION

The subject of the present invention is a sealing device (1) comprising:

a) A waterproofing membrane (2) having top and bottom surfaces and comprising at least one polymer P1 and

b) A protective film (3) comprising a backing layer (4) comprising at least one polymer P2, wherein the backing layer (4) is directly attached over at least part of its surface to the bottom surface of the waterproofing membrane (2).

Substance names beginning with “poly” designate in the present document substances which formally contain, per molecule, two or more of the functional groups occurring in their names. For instance, a polyol refers to a compound having at least two hydroxyl groups. A polyether refers to a compound having at least two ether groups.

The term “polymer” refers to a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “elastomer” refers to any polymer or combination of polymers, which is capable of recovering from large deformations, and which can be, or already is, modified to a state in which it is essentially insoluble (but can swell) in a boiling solvent. Typical elastomers are capable of being elongated or deformed to at least 200% of their original dimension under an externally applied force, and will substantially resume the original dimensions, sustaining only small permanent set (typically no more than about 20%), after the external force is released. As used herein, the term “elastomer” may be used interchangeably with the term “rubber.”

The term “α-olefin” designates an alkene having the molecular formula CₓH₂ₓ (x corresponds to the number of carbon atoms), which features a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. For example, neither 1,3-butadiene, nor 2-butene, nor styrene are referred as “α-olefins” according to the present disclosure.

The term “poly-α-olefin” designates homopolymers and copolymers obtained by polymerization or oligomerization of α-olefins or multiple distinct α-olefins.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The molecular weight may be determined by gel permeation chromatography.

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1%.

The term “softening point” refers to a temperature at which compound softens in a rubber-like state, or a temperature at which the crystalline portion within the compound melts. The softening point can be determined by Ring and Ball measurement conducted according to DIN EN 1238 standard.

The term “melting temperature” refers to a peak melting point (Tₘ) as determined by differential scanning calorimetry (DSC). The melting temperature is preferably determined by differential scanning calorimetry measurements (DSC) conducted according to ISO 11357 standard using a heating rate of 2° C./min. The measurements can be performed with a Mettler Toledo DSC 3+ device and the Tₘ values can be determined from the measured DSC-curve with the help of the DSC-software.

The term “crosslinked” refers to a polymer matrix, in which the polymer chains are inter-connected by a plurality of covalent bonds that are stable mechanically and thermally. Other possible forms of crosslinked polymers such as physically crosslinked polymers are not regarded as “crosslinked” in the context of the present disclosure. The terms “cured” and “vulcanized” may be used interchangeably with the term “crosslinked”.

The term “crosslinking degree” refers to a proportion of the component, which is insoluble in boiling xylene. The percentage of insoluble proportion can be determined by refluxing a test specimen in boiling xylene, weighting the dried residue and making suitable corrections for other soluble and insoluble components present in the tested composition. Preferably, the crosslinking degree is measured by using a method as defined ISO 10147 standard.

The “amount or content of at least one component X” in a composition, for example “the amount of the at least one polymer P” refers to the sum of the individual amounts of all polymers P contained in the composition. For example, in case the composition comprises 20 wt.-% of at least one polymer P, the sum of the amounts of all polymers P contained in the composition equals 20 wt.-%.

The term “normal room temperature” refers to the temperature of 23° C.

The waterproofing membrane, the protective film, and the backing layer are preferably planar elements having first and second major surfaces, i.e. top and bottom surfaces, defined by peripheral edges and defining a thickness of the layer there between. The term “planar element” refers in the present disclosure to sheet-like elements having a length and width at least 25 times, preferably at least 50 times, more preferably at least 150 times greater than the thickness of the element. The waterproofing membrane can be a single- or multi-ply-membrane. The term “single-ply membrane” designates in the present document membranes comprising one single layer, in particular a waterproofing layer, and the term “multi-ply membrane refers to membranes comprising more than one layers, in particular waterproofing layers, having similar or different compositions. Single- and multi-ply membranes are known to a person skilled in the art and they may be produced by any conventional means, such as by way of extrusion or co-extrusion, calendaring, or by spread coating. In case of a multi-ply membrane, the term “bottom surface of the waterproofing membrane” refers to the outer surface of the layer facing the surface of the backing layer.

The backing layer is directly attached over at least part of its surface to the bottom surface of the waterproofing membrane. The expression “directly attached” is understood to mean in the context of the present invention that no further layer or substance, such as an adhesive layer, is present between the layers, and that the opposing surfaces of the two layers are directly connected, in particular bonded to each other. At the transition area between the two layers, the materials forming the layers can also be present mixed with each other.

According to one or more embodiments, the backing layer is directly attached over at least part of its surface to the bottom surface of the waterproofing membrane through thermal bonding.

The expression “directly attached through thermal bonding” is understood to mean in the context of the present invention that that the backing layer has been thermally bonded, for example thermally laminated or heat-welded, to the bottom surface of the waterproofing membrane in a manner that gives direct bonding between the backing layer and the waterproofing membrane. The layers can be thermally bonded, for example, by applying heat to at least one of the backing layer and the bottom surface of the waterproofing membrane sufficient to at least partially melt the composition forming the respective layer(s) followed by contacting the opposing surfaces of the layers with each other, preferably under the influence of pressure, and cooling the layers, which results in formation of a thermal bond between the layers without use of an adhesive. The backing layer can be thermally bonded to the bottom surface of the waterproofing membrane in a manner that gives direct bonding between the backing layer and the waterproofing membrane, for example, by using extrusion or thermal lamination techniques.

According to one or more embodiments, the backing layer has been thermally laminated to all or part of the bottom surface of the waterproofing membrane. According to one or more further embodiments, the waterproofing membrane has been extruded to all or part of the first or second major surface of the backing layer. In these embodiments, a composition forming the waterproofing membrane is first melt-processed and then extruded through an extruder die on the surface of the backing layer.

It may be preferable that the backing layer is directly attached over its substantially entire first or second major surface to the bottom surface of the waterproofing membrane. For example, it may be preferable that at least 90%, more preferably at least 95%, most preferably at least 97.5% of the first or second major surface of the backing layer is directly attached to the bottom surface of the waterproofing membrane. It may furthermore be preferable that the backing layer and the waterproofing membrane have substantially same width and length and that the backing layer covers the entire bottom surface of the waterproofing membrane.

The composition of the waterproofing membrane is not particularly restricted but it should be as waterproof as possible and not to decompose or be mechanically damaged even under prolonged influence of water or moisture. The at least one polymer P1 is preferably a thermoplastic polymer. The at least one polymer P1 is preferably selected from the group consisting of ethylene-vinyl acetate copolymer (EVA), ethylene-acrylic ester copolymers, ethylene-α-olefin copolymers, ethylene-propylene copolymers, propylene-α-olefin copolymers, propylene-ethylene copolymers, polypropylene (PP), polyethylene (PE), polyvinylchloride (PVC), polyethylene terephthalate (PET), polystyrene (PS), polyamides (PA), chlorosulfonated polyethylene (CSPE), ethylene propylene diene rubber (EPDM), and polyisobutylene (PIB).

According to one or more embodiments, the at least one polymer P1 is selected from the group consisting of polypropylene (PP), propylene-α-olefin co-polymers, propylene-ethylene copolymers, low-density polyethylene, linear low-density polyethylene, high-density polyethylene, ethylene-vinyl acetate copolymer (EVA), ethylene-acrylic ester copolymers, ethylene-α-olefin co-polymers, and ethylene—propylene copolymers. According to one or more further embodiments, the at least one polymer P1 is selected from the group consisting of polypropylene (PP), propylene-α-olefin co-polymers, and propylene-ethylene copolymers.

Suitable polymers P1 can have a melting point, determined by differential scanning calorimetry (DSC) measurement conducted according to ISO 11357 standard using a heating rate of 2° C./min, for example, in the range of 25-250° C., preferably 55-225° C., more preferably 60-200° C., most preferably 65-150° C.

The glass transition temperature (T_{g}) of the at least one polymer P1 is preferably below the temperatures occurring during the use of the sealing device. It may therefore be advantageous that the T_{g} of the at least one polymer P1, determined by dynamical mechanical analysis (DMA) as the peak of the measured loss modulus (G″) curve using an applied frequency of 1 Hz and a strain level of 0.1%, is below 0° C., more preferably below −15° C., most preferably below −30° C.

The amount of the at least one polymer P1 in the waterproofing membrane is not particularly restricted. Preferably, the at least one polymer P1 is present in the waterproofing membrane in an amount of at least 15 wt.-%, more preferably at least 25 wt.-%, most preferably at least 35 wt.-%, based on the total weight of the waterproofing membrane. According to one or more embodiments, the at least one polymer P1 is present in the waterproofing membrane in an amount of 15-95 wt.-%, preferably 30-85 wt.-%, most preferably 35-75 wt.-%, based on the total weight of the waterproofing membrane.

The waterproofing membrane may further comprise auxiliary components, for example, UV- and heat stabilizers, antioxidants, plasticizers, fillers, dyes, pigments such as titanium dioxide and carbon black, matting agents, antistatic agents, impact modifiers, biocides, and processing aids such as lubricants, slip agents, antiblock agents, and denest aids. The total amount of the auxiliary components is preferably not more than 30 wt.-%, more preferably not more than 20 wt.-%, most preferably not more than 15 wt.-%, based on the total weight of the waterproofing membrane.

The detailed composition of the backing layer is not particularly restricted. Preferably, the at least one polymer P2 is a thermoplastic polymer. It is also preferred that the at least one polymer P2 is miscible with the at least one polymer P1 contained in the waterproofing membrane. More preferably, the at least one polymer P2 is weldable with the at least one polymer P1. The polymers being “weldable” with each other means here that a thermoplastic layer composed of the at least one polymer P1 can be homogenously joined by heat welding with another thermoplastic layer composed of the at least one polymer P2.

The amount of the at least one polymer P2 in the backing layer is not particularly restricted. Preferably, the at least one polymer P2 is present in the backing layer in an amount of at least 50 wt.-%, more preferably at least 70 wt.-%, even more preferably at least 85 wt.-%, still more preferably at least 90 wt.-%, in particular at least 92.5 wt.-%, most preferably at least 95 wt.-%, based on the total weight of the backing layer. According to one or more embodiments, the at least one polymer P2 is present in the backing layer in an amount of 50-97.5 wt.-%, preferably 55-95 wt.-%, more preferably 60-95 wt.-%, even more preferably 65-95 wt.-%, still more preferably 75-95 wt.-%, based on the total weight of the backing layer.

According to one or more embodiments, the at least one polymer P2 is selected from propylene homopolymers and propylene copolymers. The term propylene copolymer” refers in the present disclosure to a copolymer formed from propylene and ethylene and/or one or more C₄-C₂₀ α-olefin monomers wherein the propylene units are present in a major amount and the ethylene and/or α-olefin units are present in a minor amount.

Suitable propylene homopolymers to be used in the backing layer have melting temperature, determined by differential scanning calorimetry (DSC) measurement conducted according to ISO 11357 standard using a heating rate of 2° C./min, in the range of 90-190° C., preferably 100-170° C., more preferably 120-160° C. and/or a melt flow index (MFI) (230° C./2.16 kg) determined by using the method as defined in ISO 1133 standard in the range of 0.5-60 g/10 min, preferably 1.0-35 g/10 min, more preferably 1.0-20 g/10 min. Suitable propylene homopolymers are commercially available, for example, from Lyondell Basell under the trade names of Hostalen® and Moplen®.

Suitable propylene copolymers to be used in the backing layer include propylene-based olefin copolymers, for example, propylene-α-olefin random and block copolymers, in particular random and block copolymers of propylene and ethylene and/or one or more C₄-C₂₀ α-olefin monomers, in particular one or more of 1-butene, 1-pentene, 1-hexene, 1-heptene, 1-octene, 1-decene, 1-dodecene, and 1-hexadodecene. These types of propylene-α-olefin copolymers are also characterized as “plastomers” or “propylene-based elastomers”.

Suitable propylene copolymers to be used in the backing layer have a softening point determined by Ring and Ball measurement conducted according to DIN EN 1238 standard in the range of 50-180° C., preferably 60-170° C., more preferably 70-160° C. and/or a melt flow index (MFI) (230° C./2.16 kg) determined by using the method as defined in ISO 1133 standard in the range of 1.0-50 g/10 min, preferably 1.0-35 g/10 min, more preferably 1.0-20 g/10 min. Suitable propylene-based copolymers are commercially available, for example, from Dow Chemical Company under the trade name of Versify® and from Exxon Mobil under the trade name of Vistamaxx®.

According to one or more embodiments, the at least one polymer P2 is a propylene homopolymer. According to one or more embodiments, the at least one polymer P2 is a propylene copolymer.

The backing layer may further comprise auxiliary components, for example, UV- and heat stabilizers, antioxidants, plasticizers, flame retardants, fillers, dyes, pigments such as titanium dioxide and carbon black, matting agents, antistatic agents, impact modifiers, biocides, and processing aids such as lubricants, slip agents, antiblock agents, and denest aids. The total amount of the auxiliary components is preferably not more than 30 wt.-%, more preferably not more than 25 wt.-%, more preferably not more than 15 wt.-%, even more preferably not more than 5 wt.-%, based on the total weight of the backing layer.

The preferred thickness of the backing layer depends on the embodiment of the sealing device, in particular if the protective film has a single- or multi-layer structure. Preferably, that the backing layer has a thickness of at least 2.5 μm, in particular at least 5 μm. The thickness of the backing layer can be determined by using the method as defined in DIN EN 1849-2 standard. According to one or more embodiments, the backing layer has a thickness in the range of 2.5-500 μm, preferably 2.5-250 μm, more preferably 5-150 μm, most preferably 10-100 μm. According to one or more further embodiments, the backing layer has a thickness in the range of 2.5-100 μm, preferably 2.5-90 μm, more preferably 5-85 μm, even more preferably 5-75 μm, still more preferably 10-50 μm, most preferably 15-35 μm.

The backing layer is preferably a blown film or a cast film. In case the protective film is a multilayer film, it can be prepared by adhesive lamination or by co-extrusion, for example.

Preferably, the backing layer has a flexural modulus, determined by using the method as defined in ISO 178:2010 standard at a temperature of 23° C., in the range of 10-2500 MPa, more preferably 250-2000 MPa, even more preferably 500-1500 MPa, still more preferably 750-1500 MPa.

One of the advantages of the sealing device of the present invention is that the backing layer exhibits very low blocking behavior, which enables storing of the sealing devices in form of stacked sheets or rolls even at temperatures above the normal room temperature. Preferably, the backing layer has a blocking value, determined by means of the method cited in the description at a temperature of 23° C., of not more than 15.0 N/15 mm, more preferably not more than 10.0 N/15 mm, even more preferably not more than 7.5 N/15 mm, most preferably not more than 5.0 N/15 mm. It may be advantageous that the backing layer has a blocking value, determined by means of the method cited in the description at a temperature of 23° C., of not more than 3.5 N/15 mm more preferably not more than 2.5 N/15 mm, even more preferably not more than 1.5 N/15 mm, most preferably not more than 0.5 N/15 mm.

In the context of the present disclosure, the “blocking value” of a layer refers to the peeling force, which is required to separate two identical layers from each other and which is determined by using the measurement method as described below.

Measurement of the Blocking Value

The blocking value of a layer is determined based on the measurement method as defined in DIN 53366 standard. The measurement is conducted at a temperature of 23° C. using a peeling mode instead of a shearing mode, i.e. the layers are separated from each other by using a peeling force. The blocking value is determined as force in N/15 mm width of layer required to separate the two layers from each other after the layers have been pressed together for a period of 72 hours at a temperature of 50° C. using a pressure of 0.5 kg/cm2.

The sealing device may further comprise a reinforcement layer in order to improve the dimensional stability of the sealing device. The reinforcement layer is preferably at least partially embedded, preferably fully embedded into the waterproofing membrane. The type of the reinforcing layer is not particularly restricted. For example, the reinforcing layers commonly used for improving the dimensional stability of thermoplastic waterproofing and roofing membranes can be used. Preferably, the reinforcing layer comprises at least one layer of fiber material.

The term “fiber material” designates in the present disclosure materials composed of fibers. Suitable fibers to be used in the support sheet can comprise or consist of organic, inorganic or synthetic organic materials or any combination thereof. Suitable organic fibers include, for example, cellulose fibers, cotton fibers, and protein fibers. Suitable synthetic organic fibers include, for example, fibers composed of polyester, homopolymers and copolymers of ethylene and/or propylene, viscose, nylon, and polyamides. Fiber materials composed of inorganic fibers are also suitable, in particular, those composed of mineral fibers, such as glass fibers, aramid fibers, wollastonite fibers, and carbon fibers. Inorganic fibers, which have been surface treated, for example, with silanes, may also be used. The fiber material can comprise short fibers, long fibers, spun fibers (yarns), or filaments. The fibers can moreover be aligned or drawn fibers. It may also be advantageous to use a combination of different types of fibers, both in terms of geometry and composition.

The fiber material is preferably selected from the group consisting of non-woven fabrics, woven fabrics, and non-woven scrims.

The term “non-woven fabric” designates in the present disclosure materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a nonwoven fabric.

The term “non-woven scrim” designates in the present disclosure web-like non-woven products composed of yarns, which lay on top of each other and are chemically bonded to each other. Typical materials for non-woven scrims include metals, fiberglass, and plastics, in particular polyester, polypropylene, polyethylene, and polyethylene terephthalate (PET).

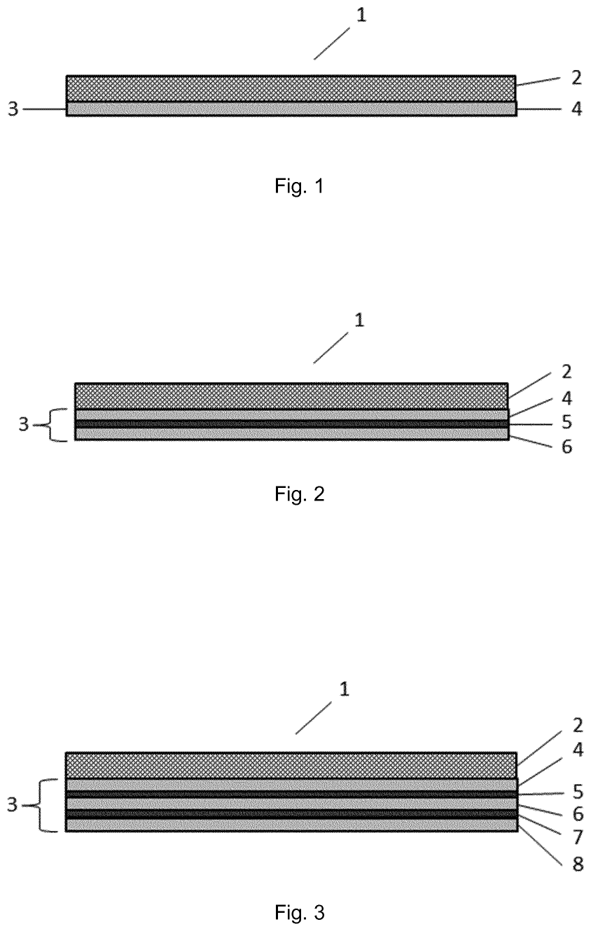

FIG. 1 shows a cross-section of a sealing device (1) comprising a waterproofing membrane (2) and a protective film (3) comprising a backing layer (4), which is directly attached over at least part of its surface to the bottom surface of the waterproofing membrane.

According to one or more embodiments, the protective film further comprises a second backing layer and a barrier layer located between the backing layers, wherein the barrier layer is directly or indirectly attached to the outer surface of the backing layer facing away from the bottom surface of the waterproofing membrane.

FIG. 2 shows a cross section of a sealing device (1) according to one embodiment of the present invention, wherein the protective film (3) comprises a backing layer (4), which is directly attached to the bottom surface of the waterproofing membrane (2), a second backing layer (6), and a barrier layer (5), which is located between the backing layers. The barrier layer (5) is directly or indirectly attached to the outer surface of the backing layer (4) facing away from the bottom surface of the waterproofing membrane (2).

Preferably, the second backing layer comprises at least one polymer P3 selected from propylene homopolymers and propylene copolymers. Suitable propylene homopolymers and propylene copolymers include the ones described above in connection with the at least one polymer P2. According to one or more embodiments, the at least one polymer P3 is identical to the at least one polymer P2.

Preferably, the at least one polymer P3 is present in the second backing layer in an amount of at least 50 wt.-%, more preferably at least 70 wt.-%, most preferably at least 90 wt.-%, based on the total weight of the second backing layer. According to one or more embodiments, the at least one polymer P3 is present in the second backing layer in an amount of 50-97.5 wt.-%, preferably 55-95 wt.-%, more preferably 60-95 wt.-%, most preferably 65-95 wt.-%, based on the total weight of the second backing layer.

Preferably, the barrier layer comprises at least 70 wt.-%, preferably at least 85 wt.-%, based on the total weight of the barrier layer, of at least one polymer P4 selected from the group consisting of polyamide (PA), polyethylene terepthalate (PET), ethylene vinyl alcohol (EVOH), polyvinyldiene chloride (PVDC), and polyethylene. According to one or more embodiments, the at least one polymer P4 is present in the barrier layer in an amount of 50-97.5 wt.-%, preferably 55-95 wt.-%, more preferably 60-90 wt.-%, most preferably 65-95 wt.-%, based on the total weight of the barrier layer.

According to one or more embodiments, the protective film further comprises a third backing layer and a second barrier layer located between the second and third backing layers, wherein the second barrier layer is directly or indirectly attached to the outer surface of the second backing layer facing away from the bottom surface of the waterproofing membrane.

FIG. 3 shows a cross section of a sealing device (1) according to one embodiment of the present invention, wherein the protective film (3) comprises a backing layer (4), which is directly attached to the bottom surface of the waterproofing membrane (2), a second backing layer (6), and a first barrier layer (5), which is located between the first and second backing layers (4, 6) as well as a third backing layer (8) and a second barrier layer (7), which is located between the second and third backing layers (6, 8). The second barrier layer (7) is directly or indirectly attached to the outer surface of the second backing layer (6) facing away from the bottom surface of the waterproofing membrane (2).

Preferably, the third backing layer comprises at least one polymer P5 selected from propylene homopolymers and propylene copolymers. According to one or more embodiments, the at least one polymer P5 is identical to the at least one polymer P3.

Preferably, the at least one polymer P5 is present in the third backing layer in an amount of at least 50 wt.-%, more preferably at least 70 wt.-%, most preferably at least 90 wt.-%, based on the total weight of the third backing layer. According to one or more embodiments, the at least one polymer P5 is present in the third backing layer in an amount of 50-97.5 wt.-%, preferably 55-95 wt.-%, more preferably 60-95 wt.-%, most preferably 65-95 wt.-%, based on the total weight of the third backing layer.

Preferably, the second barrier layer comprises at least 70 wt.-%, preferably at least 85 wt.-%, based on the total weight of the barrier layer, of at least one polymer P6 selected from the group consisting of polyamide (PA), polyethylene terepthalate (PET), ethylene vinyl alcohol (EVOH), polyvinyldiene chloride (PVDC), and polyethylene. According to one or more embodiments, the at least one polymer P6 is present in the second barrier layer in an amount of 50-97.5 wt.-%, preferably 55-95 wt.-%, more preferably 60-90 wt.-%, most preferably 65-95 wt.-%, based on the total weight of the second barrier layer.

It may be preferable that the second and third backing layers have a thickness of at least 2.5 μm, in particular at least 5 μm. The thickness of the backing layer(s) can be determined by using the method as defined in DIN EN 1849-2 standard. According to one or more embodiments, the second and third backing layers have a thickness in the range of 2.5-500 μm, preferably 2.5-250 μm, more preferably 5-150 μm, most preferably 10-100 μm. According to one or more further embodiments, the second and third backing layers have a thickness in the range of 2.5-100 μm, preferably 5-75 μm, more preferably 10-50 μm, most preferably 15-35 μm.

It may be preferable that the second and third backing layers have a flexural modulus determined by using the method as defined in ISO 178:2010 standard at a temperature of 23° C. in the range of 10-2500 MPa, more preferably 250-2000 MPa, most preferably 500-1500 MPa.

It may be preferable that the barrier layer and the second barrier layer have a thickness of at least 5 μm, in particular at least 10 μm. According to one or more embodiments, the barrier layer(s) have a thickness in the range of 2.5-500 μm, preferably 2.5-250 μm, more preferably 5-150 μm, most preferably 10-100 μm. According to one or more further embodiments, the barrier layer and the second barrier layer have a thickness in the range of 2.5-100 μm, preferably 5-75 μm, more preferably 10-50 μm, most preferably 15-35 μm.

Preferably, the barrier layer and the second barrier layer have a flexural modulus determined by using the method as defined in ISO 178:2010 standard at a temperature of 23° C. in the range of 10-2500 MPa, more preferably 250-2000 MPa, most preferably 500-1500 MPa.

According to one or more embodiments, the waterproofing membrane is composed of a composition comprising:

a′) The at least one polymer P1 and

b′) At least one elastomer E.

According to one or more embodiments, the waterproofing membrane is composed of a composition comprising:

a′) The at least one polymer P1 and

b′) The least one elastomer E, wherein the at least one polymer P1 is a thermoplastic elastomer.

Thermoplastic elastomers (TPE) is a group of polymeric materials, which exhibit rubber elasticity over a specified temperature range but which at elevated temperatures can be processed as a thermoplastic. They include a class of copolymers and blends of thermoplastic and elastomer polymer components. A typical thermoplastic elastomer is a blend of a thermoplastic polymer and an elastomer component. The components of the thermoplastic elastomer can be formed as a reactor blend, in which case the thermoplastic polymer and the elastomer are simultaneously produced in a single reactor vessel using different catalysts, or as a physical blend, wherein the components are separately produced and subsequently melt-blended using high-shear mixing technique. Thermoplastic elastomers can also be provided as a single polymer component material composed of semi-crystalline random or block copolymers containing phase separated hard (crystalline) and soft (amorphous) segments.

Commercially available thermoplastic elastomers include, for example, thermoplastic polyolefins (TPO, TPE-O), styrenic block copolymers (TPS), thermoplastic vulcanizates, (TPV), thermoplastic polyurethanes (TPU), thermoplastic copolyesters (TPC), and thermoplastic polyamides (TPA).

According to one or more embodiments, the at least one polymer P1 is a thermoplastic polyolefin (TPO) or ethylene vinyl acetate copolymer (EVA).

Thermoplastic polyolefins (TPO) are thermoplastic elastomers (TPE), which are based solely on olefinic components. These are also known as “thermoplastic olefin elastomers” or “olefinic thermoplastic elastomers” (TPE-O). Commercially available thermoplastic olefin elastomers include reactor blends, physical blends and single polymer component materials, in particular those composed of random and block copolymers of olefin monomers. A blend-type TPO typically comprises at least one polyolefin, such as polypropylene or polyethylene as the thermoplastic component and at least one olefin copolymer elastomer (OCE), such as ethylene propylene rubber (EPR) or ethylene propylene diene monomer (EPDM), as the elastomer component.

Reactor blend-type thermoplastic olefin elastomers also include commercial products, which are characterized as heterophasic copolymers or heterophasic random copolymers and impact copolymers (ICP). Heterophasic random copolymers are typically reactor blends of propylene random copolymer and ethylene propylene rubber (EPR). Typical impact copolymers comprise a semicrystalline homopolymer matrix, such as polypropylene matrix, and an elastomer phase, such as ethylene or propylene copolymer phase, which is dispersed within the homopolymer matrix. The amount of the elastomer component in impact copolymers is usually significantly lower than the amount of the homopolymer matrix, such as not more than 30 wt.-%, in particular not more than 20 wt.-%. Impact copolymer type of products containing higher amounts of the elastomeric phase are typically characterized as soft “TPOs” or “reactor TPOs”.

Suitable reactor blend-type TPOs to be used as the at least one polymer P1 are commercially available, for example, from Lyondell Basell, under the trade name of Hifax®, such as Hifax® CA 10A, Hifax® CA 12A, and Hifax® CA 212 A and under the trade names of Adflex® and Adsyl®. Further suitable reactor blend-type TPOs characterized as heterophasic random propylene copolymers are commercially available, for example, from Borealis Polymers under the trade name of Borsoft®, such as Borsoft® SD233CF.

Suitable single polymer component TPOs to be used as the at least one polymer P1 include random and block copolymers of olefinic monomers containing phase separated hard (crystalline) and soft (amorphous) segments. These types of TPOs include, for example, ethylene-α-olefin copolymers and propylene-α-olefin copolymers. Propylene-α-olefin copolymers are usually characterized as plastomers or elastomers whereas the ethylene-α-olefin copolymers are typically referred to as polyolefin plastomers (POP) or polyolefin elastomers (POE). The basic difference between plastomers and polyolefin elastomers (POE) is that plastomers tend to have somewhat less elastic properties than polyolefin elastomers.

Suitable polyolefin plastomers (POP) based on ethylene-α-olefin copolymers to be used as the at least one polymer P1 are commercially available, for example, from Dow Chemicals under the trade name of Affinity®, such as such as Affinity® EG 8100G, Affinity® EG 8200G, Affinity® SL 8110G, Affinity® KC 8852G, Affinity® VP 8770G, and Affinity® PF 1140G, and from Exxon Mobil under the trade name of Exact®, such as Exact® 3024, Exact® 3027, Exact® 3128, Exact® 3131, Exact® 4049, Exact® 4053, Exact® 5371, and Exact® 8203.

Suitable polyolefin elastomers (POE) based on ethylene-α-olefin random copolymers to be used as the at least one polymer P1 are commercially available, for example, from Dow Chemicals under the trade name of Engage®, such as Engage® 7256, Engage® 7467, Engage® 7447, Engage® 8003, Engage® 8100, Engage® 8480, Engage® 8540, Engage® 8440, Engage® 8450, Engage® 8452, Engage® 8200, and Engage® 8414

Suitable olefin block copolymers (OBC) based on ethylene-α-olefin block copolymers to be used as the at least one polymer P1 are commercially available, for example, from Dow Chemicals under the trade name of Infuse®, Infuse® 9100, Infuse® 9107, Infuse® 9500, Infuse® 9507, and Infuse® 9530.

Suitable plastomers based on propylene-ethylene copolymers to be used as the at least one polymer P1 are commercially available, for example, from Dow Chemicals under the trade name of Versify®, such as Versify® 2200, Versify® 3000, Versify® 3200, and Versify® 4200.

Suitable elastomers based on propylene-ethylene copolymers to be used as the at least one polymer P1 are commercially available, for example, from Dow Chemicals under the trade name of Versify®, such as Versify® 2300, Versify® 340, and Versify® 4301, and from Exxon Mobil under the trade name of Vistamaxx®, such as Vistamaxx® 6102, Vistamaxx® 6202, and Vistamaxx® 3000.

The preferred amount the at least one polymer P1 and the at least one elastomer E depends on the intended application of the sealing device. It may be preferable that the at least one polymer P1 is present in the composition in an amount of at least 15 wt.-%, more preferably at least 25 wt.-%, most preferably at least 35 wt.-%, based on the total weight of the composition.

The amount of the at least one elastomer E contained in the composition is not particularly restricted. Increasing the proportion of the elastomer improves the flexibility of waterproofing membrane. This may be advantageous especially in roofing applications, for example, for waterproofing of roof structures. It may be preferable that at least one elastomer E is present in the composition in an amount of at least 10 wt.-%, more preferably at least 20 wt.-%, most preferable at least 30 wt.-%, based on the total weight of the composition.

According to one or more embodiments, the composition comprises, as polymer basis, 25-85 wt.-%, preferably 35-80 wt.-%, more preferably 45-75 wt.-% of the at least one polymer P1 and/or 5-60 wt.-%, preferably 10-55 wt.-%, more preferably 15-45 wt.-% of the at least one elastomer E.

The polymer basis may comprise, in addition to the at least one polymer P1 and the at least one elastomer E, other polymers or copolymers which are not allocated to any of these categories. According to one or more embodiments, the polymer basis of the composition consists of the at least one polymer P1 and of the at least one elastomer E.

According to one or more further embodiments, the at least one polymer P1 is present in the composition in an amount of 25-95 wt.-%, preferably 30-90 wt.-%, more preferably 35-85 wt.-%, even more preferably 40-80 wt.-%, most preferably 45-75 wt.-%, based on the total weight of the composition.

According to one or more further embodiments, the at least one elastomer E is present in the composition in an amount of 5-65 wt.-%, preferably 10-50 wt.-%, more preferably 15-45 wt.-%, even more preferably 15-40 wt.-%, most preferably 15-35 wt.-%, based on the total weight of the composition.

According to one or more embodiments, the at least one polymer P1 and the at least one elastomer E are present in the composition as co-continuous phases. The expression “co-continuous” is understood to mean that the distinction between disperse and continuous polymer phases in the composition becomes difficult, as each phase becomes continuous in space. There may also be regions where the first phase appears to be dispersed within the second, and vice versa. Furthermore, each polymer is in the form of a continuous structure, wherein the structures of each polymer are intertwined with one another to form a co-continuous macrostructure.

Preferably, the at least one polymer P1 and the at least one elastomer E are compatible. By the polymers components being “compatible” is understood to mean that the properties of a blend composed of the at least one polymer P1 and the at least one elastomer E are not inferior to those of the individual polymer components. It may also be preferable that the at least one polymer P1 and the at least one elastomer E are partially miscible but not necessarily entirely miscible with each other. By the polymer components being “miscible” is understood to mean that a polymer blend composed of the at least one polymer P1 and the at least one elastomer E has a negative Gibbs free energy and heat of mixing. The polymer blends composed of entirely miscible polymer components tend to have one single glass transition point, which can be measured using dynamic mechanical thermal analysis (DMTA). The glass transition point can be determined, for example, as the peak of the measured tan delta curve (ratio of storage and loss moduli).

It may be preferable that the at least one elastomer E contained in the composition has a crosslinking degree, measured by using the method as defined in ISO 10147 standard, of not more than 10.0 wt.-%, more preferably not more than 5 wt.-%, even more preferably not more than 2.5 wt.-%, most preferably not more than 1.5 wt.-%. It may also be preferable that the at least one elastomer E is a non-crosslinked elastomer.

The at least one elastomer E is preferably selected from the group consisting of butyl rubber, halogenated butyl rubber, ethylene-propylene diene rubber (EPDM), natural rubber, chloroprene rubber, synthetic 1,4-cis-polyisoprene, polybutadiene, ethylene-propylene rubber, styrene-butadiene copolymer, isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer.

Preferred elastomers E include isobutylene-based homopolymers and copolymers. These polymers can be described as random copolymer of a C₄ to C₇ isomonoolefin derived unit, such as isobutylene derived unit, and at least one other polymerizable unit.

It may be preferable that the at least one elastomer E has a low degree of unsaturation. The term “degree of unsaturation” refers in the present document to the ratio of the number of unsaturated carbon-to-carbon bonds to the number of atoms in the linear chain of the average theoretical linear elastomer molecule. The low degree of unsaturation is preferred, for example, in roofing applications, in which the waterproofing membranes have to be able to withstand permanent exposure to various environmental factors, in particular UV-radiation. Preferably, the at least one elastomer E has a mole percent unsaturation of not more than 5.0, more preferably not more than 2.5, even more preferably not more than 1.5, most preferably not more than 0.5.

The at least one elastomer E is preferably selected from the group consisting of butyl rubbers and halogenated butyl rubbers, preferably halogenated butyl rubbers. The term “halogenated rubber” refers in the present documents to a rubber having a halogen content of at least 0.1 mol.-percent, wherein the halogen is preferably selected from the group consisting of bromine, chlorine and iodine. Preferred halogenated butyl rubbers have a halogen content of not more than 10 wt.-%, more preferably not more than 7.5 wt.-%, most preferably not more than 5.0 wt.-%, based on the total weight of the butyl rubber.

The term “butyl rubber” designates in the present document a polymer derived from a monomer mixture containing a major portion of a C₄ to C₇ monoolefin monomer, preferably an isoolefin monomer and a minor portion, such as not more than 30 wt.-%, of a C₄ to C₁₄ multiolefin monomer, preferably a conjugated diolefin.

The preferred C₄ to C₇ monoolefin monomer may be selected from the group consisting of isobutylene, 2-methyl-1-butene, 3-methyl-1-butene, 2-methyl-2-butene, 4-methyl-1-pentene, and mixtures thereof.

The preferred C₄ to C₁₄ multiolefin comprises a C₄ to C₁₀ conjugated diolefin. The preferred C₄ to C₁₀ conjugated diolefin may be selected from the group comprising isoprene, butadiene, 2,4-dimethylbutadiene, piperyline, 3-methyl-1,3-pentadiene, 2,4-hexadiene, 2-neopentyl-1,3-butadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof.

Preferred butyl rubbers are derived from a monomer mixture containing from about 80 wt.-% to about 99 wt.-% of a C₄ to C₇ monoolefin monomer and from about 1.0 wt.-% to about 20 wt.-% of a C₄ to C₁₄ multiolefin monomer. More preferably, the monomer mixture contains from about 85 wt.-% to about 99 wt.-% of a C₄ to C₇ monoolefin monomer and from about 1.0 wt.-% to about 10 wt.-% of a C₄ to C₁₄ multiolefin monomer. Most preferably, the monomer mixture contains from about 95 wt.-% to about 99 wt.-% of a C₄ to C₇ monoolefin monomer and from about 1.0 wt.-% to about 5.0 wt.-% of a C₄ to C₁₄ multiolefin monomer.

The most preferred butyl rubbers are derived from a monomer mixture comprising from about 97 wt.-% to about 99.5 wt.-% of isobutylene and from about 0.5 wt.-% to about 3 wt.-% of isoprene.

According to one or more embodiment, the at least one elastomer E is a halogenated butyl rubber, preferably a bromobutyl rubber or a chlorobutyl rubber, preferably having a halogen content in the range of 0.1-10 wt.-%, more preferably 0.5-8 wt.-%, most preferably 0.5-5.0 wt.-%, based on the total weight of the butyl rubber. According to one or more further embodiments, the at least one elastomer E is a halogenated butyl rubber, preferably a bromobutyl rubber or a chlorobutyl rubber, preferably having a halogen content in the range of 0.1-5.0 wt.-%, preferably 0.1-3.5 wt.-%, more preferably 0.1-2.5 wt.-%, most preferably 0.1-1.5 wt.-%.

It may be preferable that the waterproofing membrane has an elastic modulus, measured by using the method as defined in ISO 527-2 standard at a temperature of 23° C., of not more than 50 N/mm2, preferably not more than 25 N/mm2, most preferably not more than 15 N/mm2.

The composition may further comprise at least one hindered amine light stabilizer (HALS). These compounds are typically added to polymer blends as stabilizers against light-induced polymer degradation. Such stabilizers are needed, in particular, in case the sealing device is used in outdoor applications, for example, for waterproofing of roof structures.

According to one or more embodiments, the composition further comprises 0.1-10.0% by weight, preferably 0.1-5.0% by weight, based on the total weight of the composition, of at least one hindered amine light stabilizer (HALS).

Suitable commercially available hindered amine light stabilizers include, in particular, alkoxyamine hindered amine light stabilizers (NOR-HALS), such as:

bis-(1-octyloxy-2,2,6,6-tetramethyl-4-piperidinyl) sebacate, commercially available, for example, as Tinuvin® NOR 123 (from Ciba Chemicals, CAS number 129757-67-1); derivatives of N-butyl-2,2,6,6-tetramethyl-4-piperidinamine, commercially available, for example, as Tinuvin® NOR 152 (from Ciba Chemicals); reaction products with 3-bromo-1-propene, n-butyl-1-butanamine and N-butyl-2,2,6,6-tetramethyl-4-piperidinamine, oxidised, hydrogenated, commercially available, for example, as Tinuvin NOR® 371 (from Ciba Chemicals); reaction products of N,N′-ethane-1,2-diylbis(1,3-propanediamine), cyclohexane, peroxidized 4-butylamino-2,2,6,6-tetramethylpiperidine and 2,4,6-trichloro-1,3,5-triazine, commercially available as Flamestab NOR 116 (from BASF); and Hostavin NOW ex (from Clariant).

The composition may further comprise at least one flame retardant. These are needed, in particular, in case the sealing device is used in roofing applications, for example, for waterproofing of roof structures. According to one or more embodiments, the composition comprises 1-50% by weight, preferably 5-40% by weight, more preferably 10-40% by weight, based on the total weight of the composition, of at least one flame retardant.

The at least one flame retardant is preferably selected from the group consisting of magnesium hydroxide, aluminum trihydroxide, antimony trioxide, ammonium polyphosphate, and melamine-, melamine resin-, melamine derivative-, melamine-formaldehyde-, silane-, siloxane-, and polystyrene-coated ammonium polyphosphates.

Other suitable flame retardants include, for example, 1,3,5-triazine compounds, such as melamine, melam, melem, melon, ammeline, ammelide, 2-ureidomelamine, acetoguanamine, benzoguanamine, diaminophenyltriazine, melamine salts and adducts, melamine cyanurate, melamine borate, melamine orthophosphate, melamine pyrophosphate, dimelamine pyrophosphate and melamine polyphosphate, oligomeric and polymeric 1,3,5-triazine compounds and polyphosphates of 1,3,5-triazine compounds, guanine, piperazine phosphate, piperazine polyphosphate, ethylene diamine phosphate, pentaerythritol, borophosphate, 1,3,5-trihydroxyethylisocyanaurate, 1,3,5-triglycidylisocyanaurate, triallylisocyanurate and derivatives of the aforementioned compounds.

Suitable flame retardants are commercially available, for example, under the trade name of Martinal® and Magnifin® (both from Albemarle) and under the trade names of Exolit® (from Clariant), Phos-Check® (from Phos-Check) and FR CROS® (from Budenheim).

The composition may further comprise at least one UV-absorber selected the group consisting of hydroxybenzophenones, hydroxybenzotriazoles, triazines, anilides, benzoates, cyanoacrylates, phenylformamidines, and mixtures thereof. According to one or more embodiments, the composition comprises 0.1-10.0% by weight, preferably 0.5-5.0% by weight, based on the total weight of the composition, of at least one UV-absorber.

Suitable UV-absorbers are commercially available, for example, under the trade name of Tinuvin® (from Ciba Specialty Chemicals), such as Tinuvin® 213, 234, 320, 326-329, 350, 360, 571.

The composition may further comprise auxiliary components such as thermal stabilizers, antioxidants, plasticizers, fillers, dyes, pigments such as titanium dioxide and carbon black, matting agents, antistatic agents, impact modifiers, biocides, and processing aids such as lubricants, slip agents, antiblock agents, and denest aids. The total amount of the auxiliary components is preferably not more than 25 wt.-%, more preferably not more than 15 wt.-%, most preferably not more than 10 wt.-%, based on the total weight of the composition.

The composition as defined above may be obtained by melt-processing a starting blend comprising the at least one polymer P1 and the at least one elastomer E. The term “melt processing” refers in the present disclosure to a process, in which at least one molten polymeric component is intimately mixed with at least one other component, which may be another molten polymeric component or a solid component, such as a filler or a catalyst. The melt-processed starting blend may be used as such or further processed to a shaped article by using any conventional technique known to a skilled person, for example, extrusion, molding, or calendaring technique. Preferably, the composition is obtained by melt-processing a starting blend comprising the at least one polymer P1 and the at least one elastomer E and extruding the melt-processed starting blend through an extruder die.

The melt-processing can be conducted at a temperature, which is above the melting point of the at least one polymer P1, or in case the starting blend comprises more than one polymers P1, at a temperature, which is above the melting point of the polymer P1 having the highest melting point. The melt processing can be conducted as a batch process using any conventional mixer, such as a Brabender, Banbury, or roll mixer or as continuous process using a continuous type mixer, preferably an extrusion apparatus comprising an extruder, preferably a single screw or a twin screw extruder.

It may be preferable that the starting blend comprises, in addition to the at least one polymer P1 and the at least one elastomer E, at least one catalyst. The at least one catalyst may be present in the starting blend to catalyze chain extension and/or crosslinking and/or coupling reactions of the polymer components, in particular of the at least one elastomer E, during and/or after the melt-processing step.

The at least one catalyst is preferably selected from the group consisting of metal oxides, metal salts of fatty acids, and metal salts of boric acid, sulfur, phenol resin catalysts, fatty acids, and mixtures thereof. Suitable metal oxides and metal salts of fatty acids to be used as catalysts include, for example, ZnO, CaO, MgO, Al₂O₃, CrO₃, FeO, Fe₂O₃, NiO, and zinc salts of fatty acids having at least 6 carbon atoms, and mixtures thereof. Suitable sulfur catalysts include powdered sulfur, precipitated sulfur, high dispersion sulfur, surface-treated sulfur, insoluble sulfur, dimorpholinedisulfide, alkylphenoldisulfide, and mixtures thereof. Suitable phenol resin catalysts include, for example, bromides of an alkylphenol resin or mixed catalysts containing stannous chloride, chloroprene, or another halogen donor and an alkylphenol resin, and mixtures thereof.

The at least one catalyst, if used, is preferably present in the starting blend in an amount of not more than 10 wt.-%, more preferably not more than 7.5 wt.-%, most preferably not more than 5.0 wt.-%, based on the total weight of the starting blend. It may be preferable that the at least one catalyst is present in the starting blend in an amount of 0.1-7.5% wt.-%, more preferably 0.1-5.0 wt.-%, even more preferably 0.1-2.5 wt.-%, most preferably 0.25-2.0 wt.-%, based on the total weight of the starting blend. It is also possible that some portion of the at least one catalyst is not consumed in the reactions of the polymer components during the melt-processing and shaping steps. It may, therefore, be advantageous that the at least catalyst is also present in the composition of the waterproofing membrane. The amount of the at least one catalyst in the composition of the waterproofing membrane is preferably significantly lower than in the starting blend. It may be preferable that the composition of the waterproofing membrane comprises not more than 1.5 wt.-%, more preferably not more than 1.0 wt.-%, most preferably not more than 0.5 wt.-% based on the total weight of the composition, of the at least one catalyst.

The at least one catalyst may also be used in combination with at least one accelerator selected from the group consisting of guanidine compounds, aldehyde amine compounds, aldehyde ammonium compounds, thiazole compounds, sulfonamide compounds, thiourea compounds, thiuram compounds, xanthane compounds, and dithiocarbamate compounds. Such accelerators may be present in the starting blend in a total amount of 0.1-5.0 phr (parts by weight per 100 parts by weight of the at least one elastomer E).

According to one or more embodiments, the at least one catalyst is selected from the group consisting of ZnO, CaO, MgO, Al₂O₃, CrO₃, FeO, Fe₂O₃, NiO, zinc salts of fatty acids having at least 6 carbon atoms, preferably at least 13 carbon atoms, zinc borate, and mixtures thereof. According to one or more further embodiments, the at least one catalyst is ZnO, zinc salt of a fatty acid having at least 6 carbon atoms, preferably at least 13 carbon atoms, or zinc borate, or a mixture of ZnO and another metal oxide selected from the group consisting of CaO, MgO, Al₂O₃, CrO₃, FeO, Fe₂O₃, and NiO. Preferably the at least one catalyst is selected from the group consisting of ZnO, zinc salts of a fatty acids having at least 13 carbon atoms, in particular zinc stearate, and zinc borate.

The starting blend and the composition of the waterproofing membrane may further comprise one or more metal salts of a fatty acid different from the at least one catalyst and/or one or more fatty acids. Preferably, the metal in the metal salt of a fatty acid different from the at least one catalyst is selected from the group consisting of Zn, Ca, Mg, Al, Cr, Fe, Fe, and Ni. Preferably, the fatty acid has at least 6 carbon atoms, more preferably at least 13 carbon atoms. Saturated fatty acids having at least 6 carbon atoms, in particular at least 13 carbon atoms have been found particularly suitable.

According to one or more embodiments, the at least one catalyst is ZnO and the starting blend further comprises at least 0.05 wt.-%, preferably 0.1-0.5 wt.-%, based on the total weight of the starting blend, of at least one zinc salt of a fatty acid, preferably zinc stearate and/or at least 0.05 wt.-%, preferably 0.1-0.5 wt.-%, based on the total weight of the starting blend, at least one saturated fatty acid having at least 6 carbon atoms, preferably at least 13 carbon atoms.

According to one or more embodiments, the at least one catalyst is ZnO and the starting blend further comprises at least 0.05 wt.-%, preferably 0.1-0.5 wt.-%, based on the total weight of the starting blend, of zinc stearate and/or at least 0.05 wt.-%, preferably 0.1-0.5 wt.-%, based on the total weight of the starting blend, of a fatty acid selected from the group consisting of stearic acid and montanic acid.

The preferences given above for the waterproofing membrane, the protective film, the backing layer(s), and the barrier layer(s) apply equally to all subjects of the present invention unless otherwise stated.

Another subject of the present invention is a method for producing a sealing device comprising steps of:

i) Melt-processing a thermoplastic composition comprising the constituents of a waterproofing membrane as defined above,

ii) Extruding the melt-processed composition obtained from step i) through an extruder die, and

iii) Applying the extruded shaped melt obtained from step ii) directly on one of the major surfaces of a backing layer as defined above or

i′) Providing a waterproofing membrane as defined above and

ii′) Thermally laminating a backing layer as defined above to one of the major surfaces of the waterproofing membrane.

The thermoplastic composition comprises all the constituents of the waterproofing membrane. In embodiments, wherein the waterproofing membrane is composed of a composition comprising the components a′) and b′), the method for producing a sealing device according to the first alternative comprises steps of:

i) Melt-processing a starting blend comprising the at least one polymer P1 and the at least one elastomer E as defined above,

ii) Extruding the melt-processed composition obtained from step i) through an extruder die, and

iii) Applying the extruded shaped melt obtained from step ii) directly on one of the major surfaces of a backing layer as defined above.

The term “major surface” refers to the top and bottom surfaces of a layer defining a thickness of said layer there between. The melt processing can be conducted as a batch process using any conventional mixer, such as a Brabender, Banbury, or roll mixer or as continuous process using a continuous type mixer, such as an extrusion apparatus comprising an extruder, preferably a single screw or a twin screw extruder. Preferably, the melt-processing step is conducted using a continuous type mixer, in particular an extrusion apparatus comprising an extruder and extruder die.

In step iii) of the method, part of the thermal energy of the extruded shaped melt is introduced on the surface of the backing layer resulting in partial melting of the backing layer, which after cooling is directly bonded with the waterproofing membrane. The strength of the bond between the backing layer and the waterproofing membrane can be increased by conducting the bonding and/or cooling under pressure. For example, the membrane composite obtained from step iii) can further be drawn through spaced apart calender cooling rolls. According to one or more embodiments, the step iii) is conducted in the polishing stack or in the calender of an extruder.

The backing layer can be heated prior to, during, or after application of the shaped melt of the waterproofing membrane. Heating of the backing layer prior to the application of the shaped melt is particularly advantageous when a propylene-based water proofing membrane and propylene-based backing layer are used, because propylene homopolymers and copolymers tend to have relatively high melting points, and the heat energy introduced form the shaped melt may not be sufficient for the bonding.

According to one or more embodiments, the backing layer is heated to a temperature above normal room temperature and below the melting point of the at least one polymer P2 contained the backing layer before application of the extruded shaped melt obtained on one of the major surfaces of the backing layer.

According to one or more embodiments, the method for producing a sealing device according to the present invention comprises steps of:

i′) Providing a waterproofing membrane as defined above and

ii′) Thermally laminating a backing layer as defined above to one of the major surfaces of the waterproofing membrane.

Thermal lamination of the backing layer on one of the major surfaces of the waterproofing membrane can be conducted by using any conventional means, such as heated calendaring rolls and/or lamination wheels or hot-pressing means.

Step i′) of the method may comprise steps of melt-processing a thermoplastic composition comprising the constituents of a waterproofing membrane or melt-processing a starting blend comprising the at least one polymer P1 and the at least one elastomer E, extruding the melt-processed composition through an extruder die, and quenching the extruded web of material between calender cooling rolls.

Another subject of the present invention is a use of a protective film comprising a backing layer as defined above for reducing blocking of a polymeric membrane, wherein the backing layer is directly attached over at least part of its surface to the bottom surface of the polymeric membrane.

The preferred embodiments of the protective film and the backing layer have already been described above. According to one or more embodiments, the backing layer is directly attached over at least part of its surface to the bottom surface of the polymeric membrane through thermal bonding.

According to one or more embodiments, the backing layer has been thermally laminated to all or part of the bottom surface of the polymeric membrane. According to one or more further embodiments, the polymeric membrane has been extruded to all or part of the first or second major surface of the backing layer. In these embodiments, a composition forming the polymeric membrane is first melt-processed and then extruded through an extruder die on the surface of the backing layer

It may be preferable that the backing layer is directly attached over its substantially entire first or second major surface to the bottom surface of the polymeric membrane. For example, it may be preferable that at least 90%, more preferably at least 95%, most preferably at least 97.5% of the first or second major surface of the backing layer is directly attached to the bottom surface of the polymeric membrane. It may furthermore be preferable that the backing layer and the polymeric membrane have substantially same width and length and that the backing layer covers the entire bottom surface of the polymeric membrane.

According to one or more embodiments, the blocking value of the polymeric membrane, determined by means of the method cited in the description, is reduced to a value, which is at least 50% lower, preferably at least 75% lower, more preferably at least 85% lower than the blocking value of the polymeric membrane without the protective film on the bottom surface of the membrane.

According to one or more embodiments, the polymeric membrane comprises at least 50 wt.-%, preferably at least 75 wt.-% of at least one thermoplastic polymer selected from the group consisting of selected from the group consisting of ethylene-vinyl acetate copolymer (EVA), ethylene-acrylic ester copolymers, ethylene-α-olefin copolymers, ethylene-propylene copolymers, propylene-α-olefin copolymers, propylene-ethylene copolymers, polypropylene (PP), polyethylene (PE), polyvinylchloride (PVC), polyethylene terephthalate (PET), polystyrene (PS), polyamides (PA), chlorosulfonated polyethylene (CSPE), ethylene propylene diene rubber (EPDM), and polyisobutylene (PIB).

According to one or more embodiments, the polymeric membrane is the waterproofing membrane contained in the sealing device according to the present invention.

Still another subject of the present invention is method for covering a roof substrate, the method comprising steps of:

i″) Applying two or more sealing devices according to the present invention on the surface of the roof substrate to be covered,

ii″) Overlapping the adjacent edges of said sealing devices,

iii″) Heating the adjacent edges of the sealing devices in the overlapping areas slightly above the melting temperature of the waterproofing membrane and seaming the overlapped areas under sufficient pressure to provide acceptable seam strength without use of adhesive.

Step iii′) can be conducted manually, for example by using a hot air tool, or by using an automatic welding device, such as an automatic hot-air welding device, for example Sarnamatic® 661 welding device. The temperature to which the adjacent edges of the sealing devices are heated depends on the embodiment of the sealing device and also whether the welding step is conducted manually or by using an automatic welding device. Preferably, the edges of the adjacent edges of the sealing devices in the overlapping areas are heated to a temperature of at or above 150° C., more preferably at or above 200° C.

According to one or more embodiments, the two or more sealing devices are applied on the surface of the roof substrate such that the outer surface of the protective film is directed against the surface of the roof substrate. The term “outer surface of the protective film” refers here to the surface on the side of the protective film opposite to the side of the waterproofing membrane. The sealing devices can be adhered to the roof substrate using any conventional means, for example by mechanical fastening means, such as by using screws and/or barbed plates.

The roof substrate is preferably selected from the group consisting of an insulation board, a cover board, and an existing roofing membrane.

1. A sealing device comprising:
a) a waterproofing membrane having top and bottom surfaces and comprising at least one polymer P1 and
b) a protective film comprising a backing layer comprising at least one polymer P2, wherein the backing layer is directly attached over at least part of its surface to the bottom surface of the waterproofing membrane.

2. The sealing device according to claim 1, wherein the backing layer is directly attached over at least part of its surface to the bottom surface of the waterproofing membrane through thermal bonding.

3. The sealing device according to claim 1, wherein the at least one polymer P1 is selected from the group consisting of ethylene-vinyl acetate copolymer (EVA), ethylene-acrylic ester copolymers, ethylene-α-olefin copolymers, ethylene-propylene copolymers, propylene-α-olefin copolymers polypropylene (PP), polyethylene (PE), polyvinylchloride (PVC), polyethylene terephthalate (PET), polystyrene (PS), polyamides (PA), chlorosulfonated polyethylene (CSPE), ethylene propylene diene rubber (EPDM), and polyisobutylene (PIB).

4. The sealing device according to claim 1, wherein the at least one polymer P2 is miscible with the at least one polymer P1.

5. The sealing device according to claim 1, wherein the at least one polymer P2 is present in the backing layer in an amount of at least 70 wt.-%, based on the total weight of the backing layer and/or wherein the at least one polymer P2 selected from propylene homopolymers and propylene copolymers.

6. The sealing device according to claim 1, wherein the backing layer has a thickness of 2.5-100 μm, and/or a flexural modulus, determined by using the method as defined in ISO 178:2010 standard at a temperature of 23° C., in the range of 10-2500 MPa, and/or a blocking value, determined by means of the method cited in the description at a temperature of 23° C., of not more than 2.5 N/15 mm.

7. The sealing device according to claim 1, wherein the protective film further comprises a second backing layer and a barrier layer located between the backing layers, wherein the barrier layer is directly or indirectly attached to the outer surface of the backing layer facing away from the bottom surface of the waterproofing membrane.

8. The sealing device according to claim 7, wherein the barrier layer comprises at least 70 wt.-%, based on the total weight of the barrier layer, of at least one polymer P4 selected from the group consisting of polyamide (PA), polyethylene terepthalate (PET), ethylene vinyl alcohol (EVOH), polyvinyldiene chloride (PVDC), and polyethylene.

9. The sealing device according to claim 7, wherein the protective film further comprises a third backing layer and a second barrier layer located between the second and third backing layers, wherein the second barrier layer is directly or indirectly attached to the outer surface of the second backing layer facing away from the bottom surface of the waterproofing membrane.

10. The sealing device according to claim 1, wherein the waterproofing membrane is composed of a composition comprising:
a′) the at least one polymer P1 and
b′) at least one elastomer E.

11. The sealing device according to claim 10, wherein the composition comprises, as polymer basis, 25-85 wt. %, of the at least one polymer P1 and/or 5-60 wt.-%, of the at least one elastomer E.

12. The sealing device according to claim 10, wherein the at least one elastomer E is selected from the group consisting of butyl rubbers and halogenated butyl rubbers.

13. The sealing device according to claim 10, wherein the composition further comprises 1-50 wt.-%, of at least one flame retardant.

14. A method for producing a sealing device comprising steps of:
i) melt-processing a thermoplastic composition comprising the constituents of a waterproofing membrane as defined in claim 1,
ii) extruding the melt-processed composition obtained from step i) through an extruder die, and
iii) applying the extruded shaped melt obtained from step ii) directly on one of the major surfaces of a backing layer as defined in claim 1 or
i′) providing a waterproofing membrane as defined in claim 1 and
ii′) thermally laminating a backing layer as defined in claim 1 to one of the major surfaces of the waterproofing membrane.

15. A method of using a protective to reduce blocking of a polymeric membrane, comprising:
selecting a waterproofing membrane having top and bottom surfaces and comprising at least one polymer P1, and a protective film comprising a backing layer comprising at least one polymer P2, wherein the backing layer is directly attached over at least part of its surface to the bottom surface of the waterproofing membrane,
ensuring that the backing layer is directly attached over at least part of its surface to the bottom surface of the polymeric membrane.

16. The method according to claim 15, wherein the blocking value of the polymeric membrane is determined by means of the method cited in the description, is reduced to a value, which is at least 50% lower than the blocking value of the polymeric membrane without the protective film on the bottom surface of the membrane.

17. A method for covering a roof substrate comprising steps of:
i″) applying two or more sealing devices according to claim 1 on the surface of the roof substrate to be covered,
ii″) overlapping the adjacent edges of said sealing devices,
iii″) heating the adjacent edges of the sealing devices in the overlapping areas slightly above the melting temperature of the waterproofing membrane and seaming the overlapped areas under sufficient pressure to provide acceptable seam strength without use of adhesive.
